(19) United States
(12) Patent Application Publication
(10) Pub. No.: US 2013/0147594 A1
(43) Pub. Date: Jun. 13, 2013

(54) Transformer Structure Having Double-axis Iron Core

(71) Applicant: YUJING TECHNOLOGY CO., LTD., New Taipei City (TW)

(72) Inventor: Cheng-Yu Pan, New Taipei City (TW)

(73) Assignee: YUJING TECHNOLOGY CO., LTD, New Taipei City (TW)

(21) Appl. No.: 13/624,987

(22) Filed: Sep. 24, 2012

(30) Foreign Application Priority Data
Sep. 23, 2011 (TW) 100217870

(51) Int. Cl. H01F 3/00; H01F 27/06

(52) U.S. Cl. CPC H01F 3/00; H01F 27/06
USPC 336/208; 336/233

(57) ABSTRACT

A transformer structure having double-axis iron core is disclosed. The iron core structure mainly includes an iron core main body that has a base. The base has a parallel salient side convex part furnished respectively at the two opposite side edge thereof, and has a chamfered part furnished respectively at the two end parts corresponding to the side convex part thereof. It utilizes two iron core main bodies to be oppositely combined. In association with different shapes of coil, it is capable of forming various transformer structures and possesses a variety of combination, and is capable of adapting to various requirements of the product.

### BACKGROUND OF THE INVENTION

1. Field of the Invention

The invention relates to a transformer structure having double-axis iron core, and more particularly, to a transformer structure having double-axis iron core that is capable of using low quantity of material, high efficiency in space utilization, and having a multiplicity of variation of structural combination.

2. Description of the Prior Art

Most of the conventional common transformer structures have their coils slip on the middle part of an E-I iron core set or an E-E iron core set by making use of the

“E” and “I” iron cores to cover out of the coils so as to form a magnetic conducting loop at the periphery of the coils. Limiting by the size of the iron cores, these types of “E” and “I” silicon steel plates being furnished at the periphery of the coils make the overall size of transformer rather large and the height of it is not easy to diminish, thereby they are not suitable to make miniaturized and precise electronic products.

For the sake of the above-mentioned demerit, the author of the invention presented a utility model “Thin-type transformer Structure having Double-axis Iron Core”˜Republic of China Patent publication No. M393102. The structure includes a base, a first iron core seat, at least a first coil set, a second iron core seat, and at least a second coil set. The base has a flat surface and an axial-direction substantially perpendicular to the flat surface. The first iron core seat has a first containing space for containing a first iron core and a first wing having a height distance from the base. The first coil set is wound around the outer surface of the first iron core seat. The second iron core seat has a second containing space for containing a second iron core and has a second wing having the height distance from the base. The axial direction of the second iron core is parallel to the axial direction of the first iron core with a space between the above-mentioned axial directions. The second coil is wound around the outer surface of the first iron core seat. The height in axial direction of the transformer can be prominently lowered by having the structural design with double-axis iron core.

However, the above-mentioned structural design of transformer has the following disadvantages when it comes to application:
1. The fact that the first wing and the second wing extended respectively from the both sides of the parallel first iron core and the second iron core occupy part of the space making the space between the first and second iron cores relatively diminish causes the overall space utilization of the transformer design less economical benefits.
2. Since the first wing and the second wing furnished by extending respectively from the both sides of the first iron core and the second iron core take some space and make the overall volume of the iron core relatively large, the cost of the required material is increased accordingly.
3. As the first and the second iron cores are a combined structure that are integrally formed, not only the overall width is relatively large, it forms limitation in utilizing occasion.

Therefore, just how to resolve the above-mentioned problems has become an urgent issue to overcome the above-mentioned disadvantages and seek for an improving program in the industry.

### SUMMARY OF THE INVENTION

In light of the above-mentioned disadvantages of the prior art, the invention provides a transformer structure having double-axis iron core that is capable of overcoming the shortcomings of the prior art, satisfying the requirements of the industry, as well as improving the competitiveness in the market. It aims to ameliorate at least some of the disadvantages of the prior art or to provide a useful alternative.

The primary objective of the invention is to provide a transformer structure having double-axis iron core in which, under the premise of basic thinner design to lower the height of the transformer structure, a salient side convex part is furnished on each side of the long and flat type of base, and a chamfered part is respectively furnished at a side of both ends of the corresponding side convex part of the base, and since the two side convex parts are furnished at the side edges on both sides of the base, the use of material is economical, and the efficiency of space utilization of the overall space can be improved.

The secondary objective of the invention is to provide a transformer structure having double-axis iron core that makes use of the plurality of iron core main body to contact one another or to arrange in parallel or to be connected by their chamfered parts to form annular arrangement, and in association with different shapes of coil, it is capable of forming various transformer structure and possesses a variety of combination, and is capable of adapting to various requirements of the product.

To achieve the above-mentioned objectives and functions, a transformer structure having double-axis iron core of the invention includes at least an iron core main body having a base with a parallel side convex part furnished at each of the two parallel and opposite edges respectively.

In accordance with the above-mentioned structure, a chamfered part is furnished respectively at each end of the corresponding side convex parts of the base.

In accordance with the above-mentioned structure, the base has a rectangular thin flat body having two parallel long side edges and the two side convex part that are furnished at the inner side edge of the lengthwise-side.

In accordance with the above-mentioned structure, the base is in rectangular shape and preferably the ratio of the length and width is 2:1.

The technological means employed by the invention includes two identical oppositely furnished iron core main bodies having respectively a base where two parallel salient side convex parts are furnished at the two opposite side edges thereof and the two iron core main bodies are combined with the two side convex parts respectively by oppositely contacting each other; and two identical lead frames having a center slot for slipping over the side convex parts and a wire-winding channel for providing a space for winding a coil is furnished at the periphery of the center slot, and also a plurality of leads of the lead frame is furnished at each of the other side edges other than the side convex part of the corresponding base for connecting to the coil.

The technological means employed by the invention also includes two oppositely furnished identical iron core set) each being consisted of two identical iron core main bodies has a base that has two parallel salient side convex parts making the two iron core main bodies capable of forming an iron core set by having the side convex parts adjacently arrange side by side, and by having the corresponding side convex parts of the two iron core set oppositely contact each other to be combined together; and a lead frame having a center slot capable of being slipped on the two side convex parts. adjacently arranged side by side, has a wire-winding channel. furnished at the periphery of the center slot. for the coil. to be wound, and also has a plurality of leads. furnished at each of the other side edges other than the side convex part. of the corresponding base. for connecting to the coil.

The technological means employed by the invention further includes two oppositely furnished identical iron core set each being consisted of a plurality of identical iron core main bodies has a base that has two parallel salient side convex parts making the two iron core main bodies capable of forming an iron core set by having the side convex parts adjacently arrange side by side, and by having the corresponding side convex parts of the two iron core set oppositely contact each other to be combined together; and a lead frame having a center slot capable of being slipped on the two side convex parts adjacently arranged side by side, has a wire-winding channel furnished at the periphery of the center slot for the coil to be wound, and also has a plurality of leads furnished at each of the other side edges other than the side convex part of the corresponding base for connecting to the coil.

In accordance with the above-mentioned structure, the base is rectangle in shape, and the chamfered parts are furnished at each of the end angle parts

The accomplishment of this and other objectives of the invention will become apparent from the following description and its accompanying drawings of which:

### BRIEF DESCRIPTION OF THE DRAWINGS

FIG. 1 is an isometric exploded view of the first embodiment of the iron core structure of the transformer structure having double-axis iron core of the invention.

FIG. 2 is an isometric view of the first embodiment of the schematic assembled transformer structure having double-axis iron core of the invention.

FIG. 3 is an isometric exploded view of the second embodiment of the iron core structure of the transformer structure having double-axis iron core of the invention.

FIG. 4 is an isometric view of the second embodiment of the schematic assembled transformer structure having double-axis iron core of the invention.

FIG. 5 is an isometric exploded view of the third embodiment of the iron core structure of the transformer structure having double-axis iron core of the invention.

FIG. 6 is an isometric view of the third embodiment of the schematic assembled transformer structure having double-axis iron core of the invention.

### DETAILED DESCRIPTION OF THE PREFERRED EMBODIMENT

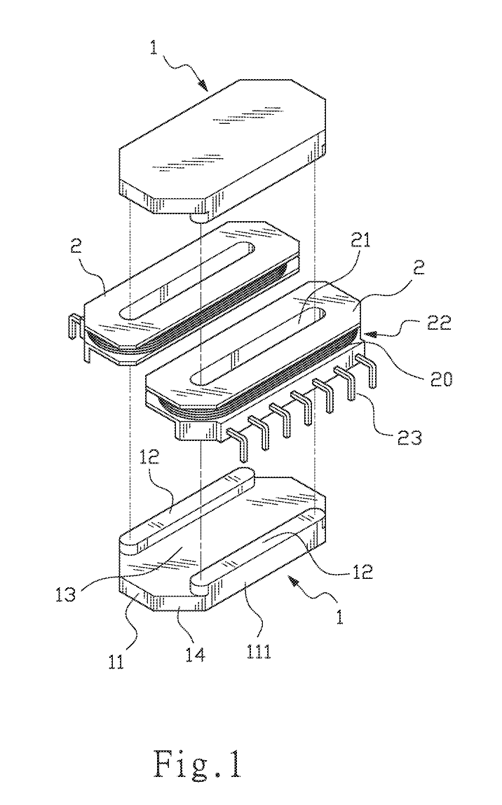

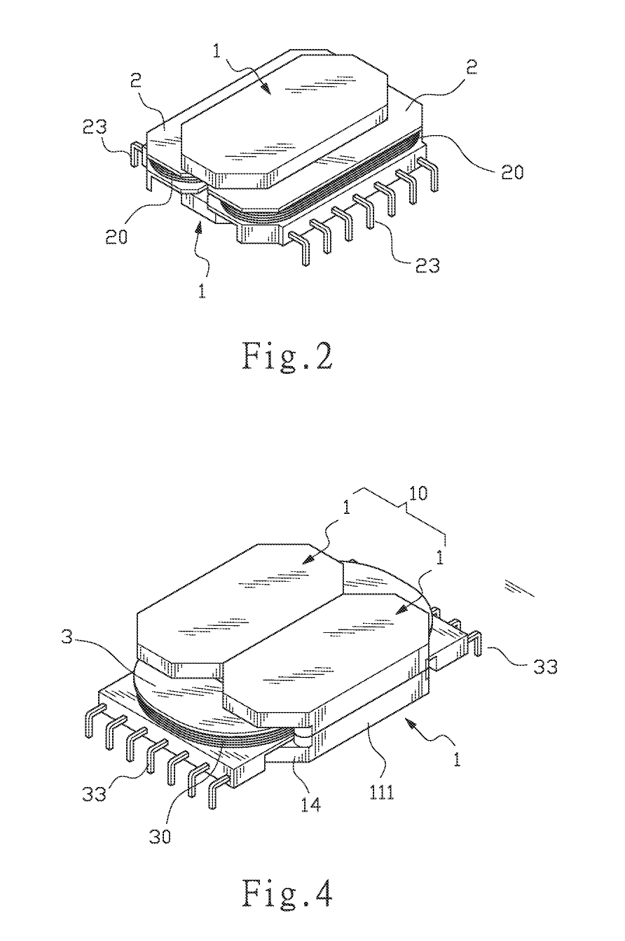

FIG. 1 is an isometric exploded view of the transformer structure having double-axis iron core of the invention. FIG. 1 is an isometric exploded view of the first embodiment of the iron core structure of the transformer structure having double-axis iron core of the invention while FIG. 2 is an isometric view of the first embodiment of the schematic assembled transformer structure having double-axis iron core of the invention. As shown in FIG. 1 and FIG. 2, an iron core structure of the transformer structure having double-axis iron core of the invention includes an iron core main body (1) having a base (11) that a side convex part (12) on each of the two parallel and opposite edge is furnished respectively thereof making a containing space (13) naturally forms between the two side convex parts (12). Moreover, a chamfered part (14) is furnished respectively on each end of the side convex parts (12) of the base (11). What is more, the base (11) can be a rectangular thin flat body (the ratio of the length and width is preferably 2:1) where the two side convex parts (12) are furnished on the inner side edges of the lengthwise-side (111).

In the first embodiment of the invention, the iron core main body (1) is capable of combing with another identical iron core main body (1) in coordination with two identical lead frames (2) wherein the lead frame (2) has a center slot (21) for slipping over the side convex part (12). Moreover, a wire-winding channel (22) for providing a space for winding a coil (20) is furnished at the periphery of the center slot (21). What is more, a plurality of leads (23) for connecting to the coil (20) are furnished at the outer edge of the lead frame (2) corresponding to the base (11). In addition, the other iron core main body (1) is combined with the opposite corresponding iron core main body (1) by having their corresponding side convex parts (12) contact each other making the two lead frames (2) and the coil (20) capable to combine together between the two opposite iron core main bodies (1). In this way, each of the leads (23) are stretched toward the direction of the two outer side convex parts (12) to form a transformer structure.

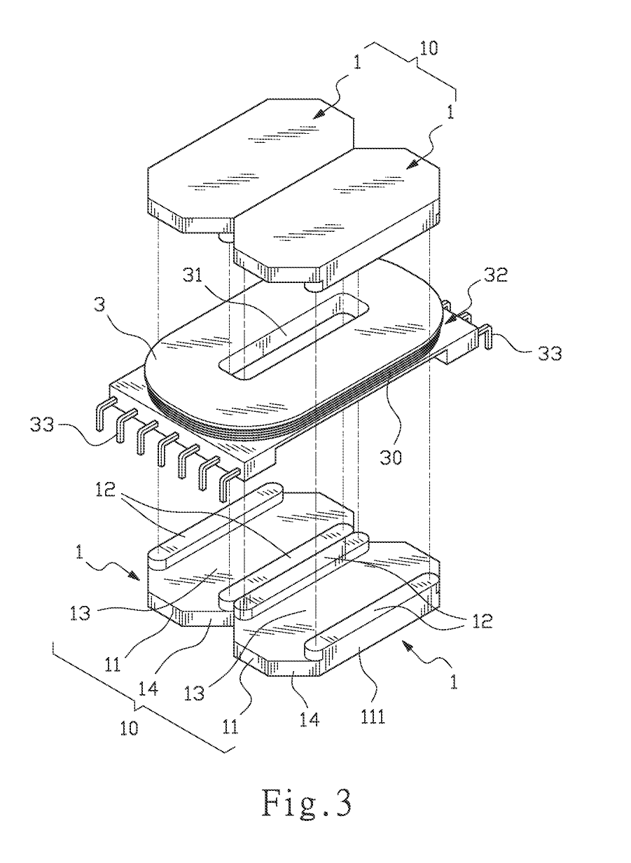

FIG. 3 is an isometric exploded view of the second embodiment of the iron core structure of the transformer structure having double-axis iron core of the invention while FIG. 4 is an isometric view of the second embodiment of the schematic assembled transformer structure having double-axis iron core of the invention. As shown in FIG. 3, and FIG. 4, the second embodiment of the iron core structure of the transformer structure having double-axis iron core of the invention mainly includes two iron core sets (10) and a lead frame (3) where the iron core sets (10) are combined by having the identical iron core main bodies (1) arrange adjacently and in parallel by side convex parts (12) respectively and the two iron core sets (10) are combined by having the corresponding side convex parts (12) oppositely contact each other. The lead frame (3) has a center slot (31) for slipping over the side convex parts (12) that are arranged adjacently and in parallel with the iron core sets (10). Moreover, a wire-winding channel (32) for providing a space for winding a coil (30) is furnished at the periphery of the center slot (31). What is more, a plurality of leads (33) for connecting to the coil (30) is furnished at each of the other side edges other than the side convex part (12) corresponding to the base (11) of the lead frame (3).

In the above-mentioned structure, after combining with the two iron core sets (10), the lead frame (3) is capable of having its wire-winding channel (22) and coil (20) exactly contain in the containing space (13) of the two iron core main bodies (1) and having part of itself expose out of the two iron core main bodies (1). Moreover, another transformer structure is formed by having the plurality of leads (23) that are furnished on both ends of the lengthwise-side (111) of the two iron core main bodies (1), thereby another kind of transformer structure is formed.

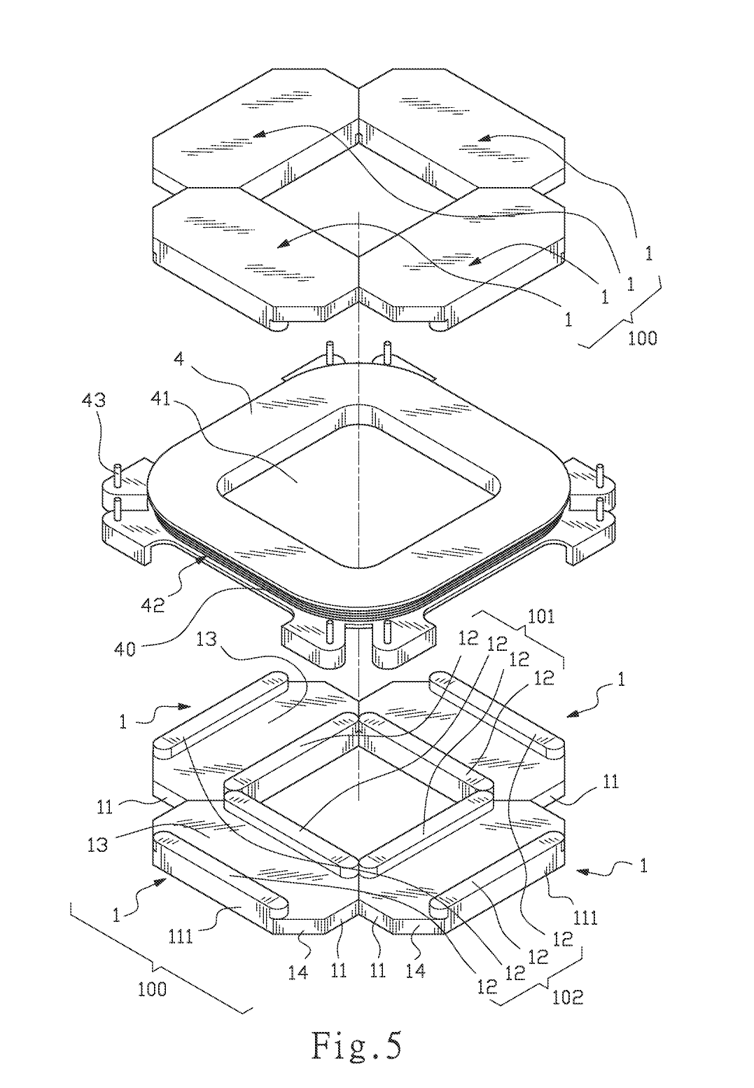

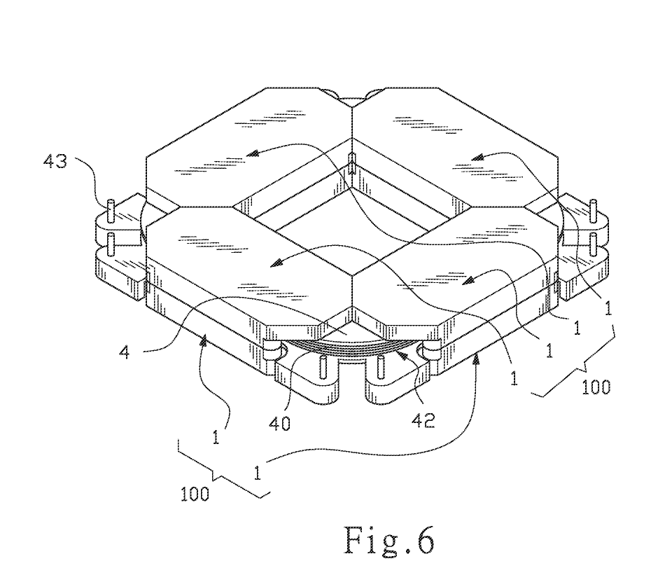

FIG. 5 is an isometric exploded view of the third embodiment of the iron core structure of the transformer structure having double-axis iron core of the invention while FIG. 6 is an isometric view of the third embodiment of the schematic assembled transformer structure having double-axis iron core of the invention. As shown in

FIG. 5 and FIG. 6, the third embodiment of the transformer structure having double-axis iron core of the invention includes two iron core sets (100) and a lead frame (4). The iron core sets (100), each has four chamfered parts (14) at its four corners, are formed into an annular connecting body by having their chamfered part (14) contact one another with four near-center inner side convex parts (101) and four far-center outer side convex part (102). The two iron core sets (100) are also combined together by oppositely having each of its near-center inner side convex parts (101) and each of its far-center outer side convex part (102) contact one another. The lead frame (4), having a center hole (41) for being slipped on by the near-center inner side convex parts (101), has a wire-winding channel (42) at the periphery thereof for being wound by the coil (40) and has a plurality of leads (43) furnished at the side of the connecting part of each of the iron core main body (1) of the iron core set (100) corresponding to the lead frame (4).

In the above-mentioned structure, after combining with the two iron core sets (100), the lead frame (4) is capable of having its wire-winding channel (42) and coil (40) exactly contain in the containing space (13) of the two iron core main bodies (1) and having part of itself expose out of the two iron core main bodies (1). Moreover, each of the leads (43) of the lead frame (4) is furnished on the outer side of the connecting part of the each of the iron core main body (1) and will not protrude out of the covered area of the iron core set (100), thereby is capable of effectively diminishing its occupying space, thereby, another kind of transformer structure is formed.

When it comes to practical application, in the structure of the third embodiment of the transformer structure having double-axis iron core of the invention, a polygonal annular connecting body (not limited to a pure quadrilateral annular connecting body) can be formed by a plurality of iron core main bodies (1) in coordination with the angle of the chamfered part (14). Moreover, a transformer structure having a polygonal iron core set (100) can also be formed in coordination with the lead frame structure having the similar shape.

In conclusion, the transformer structure having double-axis iron core of the invention indeed possesses the efficacies of lowing the cost of material, improving efficiency of space utilization, and generating a multiplicity of product having combinational variation to meet the patentability of having industrial utilization, non-obviousness and progressiveness subject matter.

It will become apparent to those people skilled in the art that various modifications and variations can be made to the structure of the invention without departing from the scope or spirit of the invention. In view of the foregoing description, it is intended that all the modifications and variation fall within the scope of the following appended claims and their equivalents.

What is claimed is:

1. A transformer structure having double-axis iron core, comprising at least an iron core main body having a base with a parallel side convex part furnished at each of the two parallel and opposite edges respectively.

2. The transformer structure having double-axis iron core as claimed in claim 1, wherein a chamfered part is furnished respectively at each end of the corresponding side convex parts of the base.

3. The transformer structure having double-axis iron core as claimed in claim 2, wherein the base has a rectangular thin flat body having two parallel long side edges and the two side convex part that are furnished at the inner side edge of the lengthwise-side.

4. The transformer structure having double-axis iron core as claimed in claim 3, wherein the base is in rectangular shape and preferably the ratio of the length and width is 2:1.

5. A transformer structure having double-axis iron core, at least comprising:
two identical oppositely furnished iron core main bodies having respectively a base where two parallel salient side convex parts are furnished at the two opposite side edges thereof and the two iron core main bodies are combined with the two side convex parts respectively by oppositely contacting each other; and
two identical lead frames having a center slot for slipping over the side convex parts and a wire-winding channel for providing a space for winding a coil is furnished at the periphery of the center slot, and also a plurality of leads of the lead frame is furnished at each of the other side edges other than the side convex part of the corresponding base for connecting to the coil.

6. A transformer structure having double-axis iron core, at least comprising:
two oppositely furnished identical iron core set each being consisted of two identical iron core main bodies has a base that has two parallel salient side convex parts making the two iron core main bodies capable of forming an iron core set by having the side convex parts adjacently arrange side by side, and by having the corresponding side convex parts of the two iron core set-winding channel furnished at the periphery of the center slot for the coil to be wound, and also has a plurality of leads furnished at each of the other side edges other than the side convex part of the corresponding base for connecting to the coil.

7. A transformer structure having double-axis iron core, at least comprising:
two oppositely furnished identical iron core set each being consisted of a plurality of identical iron core main bodies has a base that has two parallel salient side convex parts making the two iron core main bodies capable of forming an iron core set by having the side convex parts adjacently arrange side by side, and by having the corresponding side convex parts of the two iron core set oppositely contact each other to be combined together; and
A lead frame having a center slot capable of being slipped on the two side convex parts adjacently arranged side by side, has a wire-winding channel furnished at the periphery of the center slot for the coil to be wound, and also has a plurality of leads furnished at each of the other side edges other than the side convex part of the corresponding base for connecting to the coil.

8. The transformer structure having double-axis iron core as claimed in claim 7, wherein the base is rectangle in shape, and the chamfered parts are furnished at each of the end angle parts.
